(19) United States
(12) Patent Application Publication
(10) Pub. No.: US 2012/0137579 A1
(43) Pub. Date: Jun. 7, 2012

(54) Bulb planting and storage container

(76) Inventor: Larry Gardenour, Merrimack, NH (US)

(21) Appl. No.: 13/373,767

(22) Filed: Nov. 29, 2011

Related U.S. Application Data
(60) Provisional application No. 61/458,835, filed on Dec. 2, 2010.

(51) Int. Cl. A01G 9/02

(52) U.S. Cl. 47/65.8

(57) ABSTRACT

A container for planting, storing and preserving bulbs, etc. and also serving to facilitate replanting again. The container is made from flexible material that can be buried and then stored time after time without degradation of the material. The container has handles so that the container can be easily removed from the ground to store the bulbs without the need of a shovel or spade that might damage the bulb. The container keeps at least a portion of the root system of the bulb during storage so that bulbs can more quickly re-establish themselves when replanted. Different sizes are available for any size bulbs. V-shaped flaps enable the root system to grow outside the bounds of the container. The aligned flaps also provide a visual gauge to determine the proper planting depth.

This application claims benefit of U.S. Provisional Application Ser. No. 61/458,835, filed Dec. 2, 2010 pursuant to 35 USC §119(e).

### FIELD OF THE INVENTION

This invention relates to storage and planting apparatus, in particular, an apparatus for preserving and storing bulbs, tubers, etc. and then also serving to facilitate replanting again.

### BACKGROUND OF THE INVENTION

Use of bulbs to obtain flowering plants is a particularly desirable way to achieve attractive landscaping. Bulbs provide a good investment for money spent and supplies years of spring and summer color in the planter's garden. Numerous flowering plant varieties are available. For example, Alliums, Anemones, Crocus, Daffodils, Eranthis, Galanthus,Hyacinths, Iris, Muscari, and Scilla are popular choices for the home gardener. Of course, the most popular bulbs are Tulips, which offer a wide range of colors and blooms. With proper care and attention, bulbs can last for a long time and provide many years of enjoyment for the home gardener.

Bulbs can frequently be left in the ground in temperate climates. However, in colder regions, typically, once the flowers have bloomed, the bulbs are dug up and stored indoors to protect them from freezing. Even in more moderate climates, an unusually cold spell can result in the loss of expensive bulbs if they are left in the ground so it is quite common for most home gardeners to remove them for storage to be replanted in the spring.

If the choice is to dig bulbs, they should be stored in a well-ventilated place and replanted at the appropriate time depending on the particular plant. It is recommended that every five years daffodils and crocus should be dug and replanted to prevent overcrowding and encourage growth.

Most summer flowering bulbs should be dug up and stored when the leaves on the plants turn yellow. This is usually done by the use of a spading fork to lift the bulbs from the ground. For most bulbs, it is suggested that any soil that clings to the bulbs is washed off except for bulbs that are stored in pots or with the soil around them. Then, the bulbs are stored away from sunlight in a cool, dry basement, cellar, garage or shed at 60° to 65° F. Temperatures below 50° or above 70° F. are avoided unless different instructions are given for a particular bulb. If only a few bulbs are being stored, then they can be placed in paper bags and hung by strings from the ceiling or wall. Large numbers of bulbs on trays with screen bottoms are typically stored on trays.

During the removal process, it is frequently a problem that expensive bulbs can be destroyed by being cut by a shovel during the digging process. Also, it is possible that some bulbs can be overlooked.

Once the bulbs are to be replanted, it is necessary to plant them at the proper depth, which varies from plant to plant.

At present, there is no device found in the prior art that serves as a container to both store and preserve bulbs and then also functions as a planting aid which ensures planting at the proper depth and with proper nutrients surrounding each bulb to provide an early start in the growing process thus resulting in bigger flowers and more blossoms.

### SUMMARY OF THE INVENTION

It is an aspect of the invention to provide a bulb storage and planting container that is composed of a flexible material that can be planted in the ground and removed in the fall without degradation of the material for many years.

It is another aspect of the invention to provide a bulb storage and planting container that has a pair of handles so that the container with the bulbs inside can be easily removed from the ground to store the bulbs.

Another aspect of the invention is to provide a bulb storage and planting container that keeps at least a portion of the root system of the bulb during storage so that the bulbs can more quickly re-establish themselves when replanted.

It is still another aspect of the invention to provide a bulb storage and planting container that can be used with any size bulbs.

Another aspect of the invention is to provide a bulb storage and planting container that enables a gardener to easily determine the proper depth at which to plant the bulbs.

It is an aspect of the invention to provide a bulb storage and planting container that requires no shovel in order to remove the bulbs from the ground.

Another aspect of the invention is to provide a bulb storage and planting container that can also be used with perennials that are for sale since the root system will be retained with the plant and can be replanted easily and quickly thus providing less shock to the transplanted perennials.

Finally, it is an aspect of the invention to provide a bulb storage and planting container wherein once the bulbs are in the container, it is unnecessary to remove them whether the bulbs are to be stored or planted unless it is desirable to split them.

### BRIEF DESCRIPTION OF THE DRAWINGS

FIG. 1 is a front/rear view of the bulb storage and planting container in accordance with the invention.

FIG. 2 is a front/rear view of an alternative embodiment of the bulb storage and planting container.

### DETAILED DESCRIPTION OF THE INVENTION

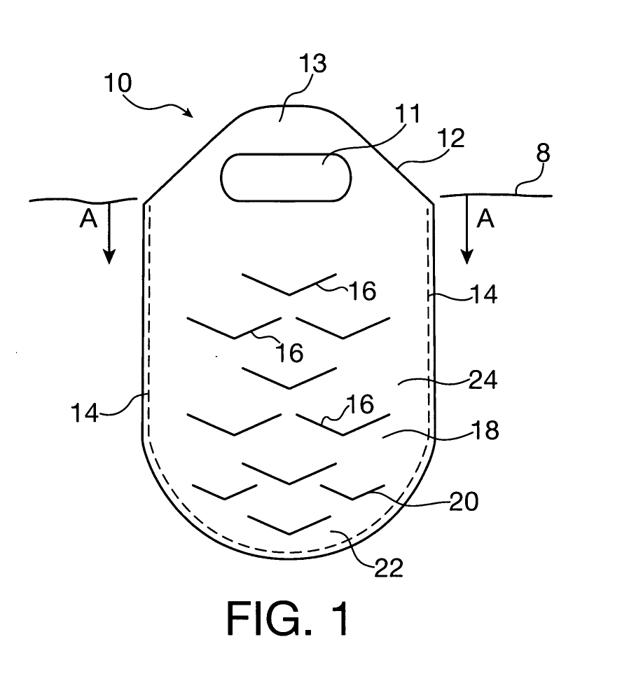

As shown in FIG. 1, the bulb storage and planting container 10 is a flexible bag having a front panel 12 and an identical rear panel 12 that are fastened together along fastened line 14 to form a bag. Fastened line 14 can be either stitched or electro-welded. The preferable material for the panels is 18-ounce vinyl with a double weave polyester backing to make the material tear-resistant. The vinyl is also preferably UV and mildew resistant. It is expected that the use of this type of material will provide at least a five-year useful life. However, other materials that are as durable and flexible and cannot be degraded while being buried for an extended period of time would also be suitable. Panel 12 is preferably die-cut so that the panels can be quickly manufactured.

Each panel has an integral handle 13 with a hand opening 11 provided therein. V-shaped flaps 16 are die-cut into the panel. Note that the apexes of the V of each flap 16 are aligned at distances 18, 20, 22 and 24, which corresponds to a predetermined distance from reference line 8. This enables the user to easily bury container 10 in the ground at a desired depth.

This particular size container 10 is preferably about 6 inches in width and 7 ½ inches in depth measured from reference line 8 to the bottom of container 10. The larger flaps 16 are about 2 inches wide and about ½ inch measured from the top of each flap 16 to the apex of the V. These dimensions and number of flaps 16 are not critical but ten flaps 16 have been found to be sufficient for a container 10 of this size. This size would be suitable for one or two bulbs.

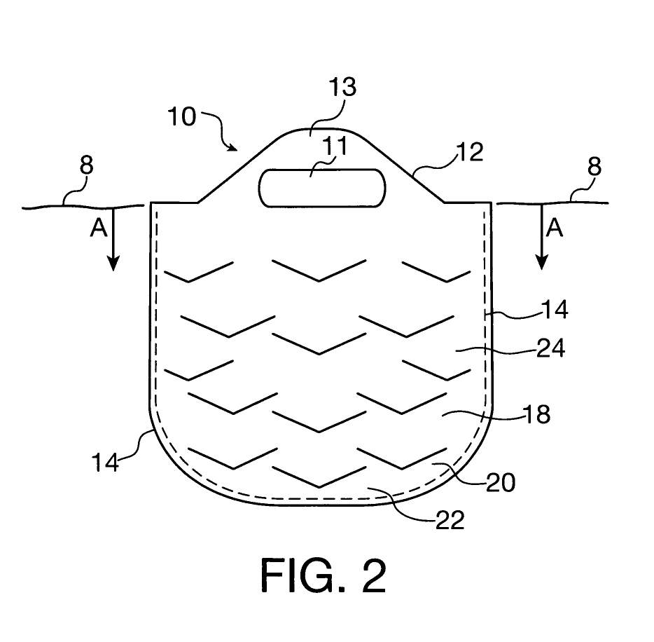

As shown in FIG. 2, a larger size of container 10 is provided. This size would be suitable for 2 or 3 dahlia tubers, for example. In this embodiment, the width of container 10 is about 9 inches and the length from reference line 8 is about 8 inches. Flaps 16 are preferably about the same size as shown in FIG. 1. Again, the apex of the various flaps 16 are aligned at predetermined distances from reference line 8 so that the correct depth to plant the bulbs contained in container 10 can easily be determined.

As noted above, each V-shaped flap 16 is at a predetermined depth from reference line 8 in direction A. This distance will correspond to the depth that container 10 is buried in the ground. The depths vary from 2 inches to 7 inches.

The user places soil or planting medium in the bag up to flap 16 that corresponds to the desired depth of planting for that particular bulb. This makes it easy to plant a bulb at the ideal depth.

The soil is then packed down and the bulb(s) are inserted into the bag. More soil or planting medium is placed into the bag and packed down until it is filed to the top rim (referenced line 8). A hole is dug into the ground so it is deep enough such that the filled bag can be inserted in direction A. Once the bag is in the hole, soil is packed securely around the bag and handles 13 are pushed down around the bag so that handles 13 won't show; then water and fertilizer is added that is consistent with common gardening practices.

After the growing season has ended (or after the first frost in colder climates), cut back the plant to the top edge (reference line 8) of the bag. Then merely unfold the handles 13 from the bag and pull the bag out of the ground with the soil and bulbs contained therein. No shovel is required. Store the bag with the bulbs and soil for easily replanting at the next growing season. Bags are best stored in a dry, cool place. The bulbs won't dry out and less time is required to clean the bulbs. When the bags are replanted in the spring, the root system in the bag enables the bulb to grow more quickly.

The only time that the bulbs need to be removed from the bag is when the bulbs such as gladiolas need to be split. In such cases, merely remove the bulb from the container 10, split it and discard the old bulb then let the new bulb dry and place it in its own bag for replanting.

Bulbs grown in the bag will have a root system in the bag, which can extend beyond the bag via flaps 16. The bag also protects the bulb(s) contained therein from moles or voles. Further, if fertilizer is placed in the bag along with soil, the fertilizer will stay with the bulb longer for better growth.

Further, houseplants can be placed in container 10 for planting outside during the summer months. Merely remove the bag from the ground before the frost in the fall; the bag along with new root system extending beyond the bag through flaps 16 will follow for replanting indoors in a pot.

Commercial growers can use the invention for growing perennials that they intend to sell. By growing the perennials in the invention, the growers can remove the bag and the attached root system that has grown through flaps 16 and then the bag and the attached roots can be replanted the same day with less shock to the plant.

Although the present invention has been described with reference to certain preferred embodiments thereof, other versions are readily apparent to those of ordinary skill in the preferred embodiments contained herein.

What is claimed is:

1. A bulb storage and planting container comprising:
a front panel of flexible attachable material having a perimeter and a back panel also of flexible attachable material also having a perimeter wherein said front panel is permanently attached to said back panel along a first portion of each panel's perimeter to provide continuous fastening section and a second portion of each panel's perimeter that is left unfastened to provide a continuous fill section such that said container is a bag-like structure wherein said bulb storage and planting container can be filled via said fill section with at least one bulb having a root system when planted.

2. The bulb storage and planting container of claim 1 further comprising:
a plurality of V-shaped slits to provide a plurality of flaps on said front panel and said back panel wherein the apexes of each V are aligned to a plurality predetermined distances from a ground reference line such that the aligned V-shaped slits enables a user to bury said container in the ground at the predetermined planting depth corresponding to said ground reference line.

3. The bulb storage and planting container of claim 1 further comprising:
an opening in each panel adjacent to the fill section perimeter of each panel such that each said opening in each panel provides a handle for removing said container once the seasonal time for storage of said container has been reached and wherein said container can be removed from the ground by pulling up on said handle without the need for a shovel or spade to remove the at least one bulb and planting soil contained therein, said container along with at least a part of the root system attached to said bulb.

4. The bulb storage and planting container of claim 1 wherein said flexible material is UV and mildew resistant and will not be significantly degraded when buried for an extended period of time corresponding to the expected growing season length of time.

5. The bulb storage and planting container of claim 4 wherein said flexible material is a double weave polyester thread scrim reinforcing a vinyl sheet material.

6. The bulb storage and planting container of claim 3 wherein said handle is used to pull up said container from the ground.

7. The bulb storage and planting container of claim 2 wherein the plurality of flaps are aligned to provide a range of planting depths ranging from 2 to 7 inches with the size of the flaps corresponding to the depth below the ground reference line which corresponds to the preferred planting depth for the type of the at least one bulb being planted.

8. The bulb storage and planting container of claim 1 wherein said container with at least one bulb is also filled with planting medium prior to planting said container and then watered and fertilized in accordance with well known gardening techniques specific to the type of at least one bulb being planted.
